(19) United States
(12) Patent Application Publication
(10) Pub. No.: US 2026/0159730 A1
(43) Pub. Date: Jun. 11, 2026

(54) ELECTRICALLY DETACHABLE ADHESIVE TAPE SYSTEM COMPRISING A FILM D OF A HEAT-ACTIVATABLE REACTIVE ADHESIVE AND A PRIMER COMPOSITION

(71) Applicant: tesa SE, Norderstedt (DE)

(72) Inventors: Dennis DOCKWEILER, Hamburg (DE); Alexander FISCHER, Norderstedt (DE)

(73) Assignee: tesa SE, Norderstedt (DE)

(21) Appl. No.: 19/413,990

(22) Filed: Dec. 9, 2025

(30) Foreign Application Priority Data
Dec. 10, 2024 (DE) 102024136914.0

(51) Int. Cl. C09J 7/35; C09J 9/02; C09J 11/06

(52) U.S. Cl. CPC C09J 7/35; C09J 9/02; C09J 11/06; C09J 2301/502; C09J 2475/003

(57) ABSTRACT

The invention relates to an adhesive tape system comprising a film D composed of a heat-activatable reactive adhesive and a primer composition, to a method of producing a bonded composite using the adhesive tape system, to the bonded composite produced by the method, to a method of electrically debonding the bonded composite and to the use of the bonded composite.

The tape system comprises
(i) a film D of a reactive heat-activatable adhesive, where the reactive heat-activatable adhesive contains at least one electrolyte; and
(ii) a primer composition which is intended to form a separate layer and contains at least the following constituents:
   (a) at least one thermoplastic polyurethane; and
   (b) at least one organosilane.

The invention relates to an adhesive tape system comprising a film D composed of a heat-activatable reactive adhesive and a primer composition, to a method of producing a bonded composite using the adhesive tape system, to the bonded composite produced by the method, to a method of electrically debonding the bonded composite and to the use of the bonded composite.

Bonding of metal parts to plastics is typically accomplished using double-sided pressure-sensitive adhesive tapes. The strength of adhesion forces this entails are sufficient for fixing and securing the metal components on the plastics. Metals used are preferably steel, stainless steel, and aluminium. Examples of plastics used are PVC, ABS, PC, or blends based on these plastics. In addition, electrically non-conductive materials are rendered electrically conductive and are likewise bonded by suitable electrically conductive coatings or the like.

However, the requirements for portable consumer electronics are constantly increasing. These articles are becoming smaller and smaller, and so the bond areas too are diminishing. These conditions are particularly problematic for metal bonds on plastics. This bonding can be accomplished with particular efficiency by using heat-activatable films which are able to develop a particularly high bond strength after the activation.

DE 10 2021 200 580 A1 discloses, for example, an adhesive film which is cured by means of heat supply, wherein the adhesive film is based on a preparation in organic solvent which contains a thermoplastic polymer, which can react with isocyanate via functional groups, and a corresponding isocyanate-containing crosslinker component. However, not all substrates to be bonded are suitable for activation temperatures of 80° C. or more.

In recent times there has additionally been increased interest in “debonding-on-demand” functionalities, this being driven by environmental legislation and end-customer awareness of sustainability and by increasing cost pressures in production. The use scenarios for debonding processes are classified into rework, repair, recycling, and processing aids.

Debonding technologies aim to achieve a cohesive split in the adhesive layer or an adhesive detachment of the adhesive layer from the substrate. While the former in any case requires cleaning of at least one substrate before rebonding, the latter leaves a substrate free of residue. Adhesive splitting is thus preferred in order to avoid an additional cleaning step that could possibly impair the substrate characteristics. However, adhesive debonding technologies that guarantee the required high and enduringly reliable bond strength are generally relatively difficult to realize or their application, for example detachment using an infiltrating solvent, is very time-consuming. For instance, particularly in the rework or repair of electronic devices, such as smartphones and tablet computers, it is predominantly cohesively splitting adhesive bonds that are currently employed, often in the form of pressure-sensitive adhesive tapes, the cohesion of which is reduced by an increase in temperature to such an extent that manual, cohesive separation of the bond can take place. This results in extensive rework to prepare the substrate surface contaminated with adhesive residues for rebonding.

In addition to heat-mediated separation methods, electrical separation methods are being discussed. For example, EP 3 031 875 B1 discloses lowering the strength of adhesion of an acrylate adhesive containing a surfactant by applying a voltage. For example, this achieves a reduction in adhesion strength by 29% to 98%.

However, heat-activatable adhesive bonds generally exhibit very high bond strengths. These adhesive tape solutions are normally not redetachable, at least not without damaging the substrates bonded using them and without applying a very high force.

It is therefore an object of the present invention to provide an adhesive tape system for producing a heat-activatedly bonded and optionally re-debondable composite, wherein the removal of the adhesive by means of a gentle separation method is to be enabled with a minimum level of residue and with low application of force. At the same time, the method of producing the bonded composite should already be performable in a substrate-conserving manner. In addition, the bonded composite should have improved bond strength and improved shock resistance.

The object is achieved by the adhesive tape system according to the invention and by the method according to the invention for producing a bonded composite and hence also by the bonded composite produced by the method according to the invention. The object is also achieved by the method according to the invention for electrically debonding the bonded composite and the use of the bonded composite.

Embodiments that are hereinafter designated as preferred, in particularly preferred embodiments, are combined with features of other embodiments designated as preferred. Very particular preference is therefore given to combinations of two or more of the embodiments designated hereinafter as particularly preferred. Preference is likewise given to embodiments in which a feature of one embodiment designated as preferred to any extent is combined with one or more further features of other embodiments designated as preferred to any extent. The invention thus encompasses combinations of individual features with one another and also with different levels of preference in said combinations. For example, then, the invention encompasses the combination of a first feature designated as “preferred” with a second feature designated as “particularly preferred”. Features of preferred bonded composites and uses and methods of debonding will be apparent in particular from the features of preferred adhesive tape systems and/or methods of producing the bonded composite.

The adhesive tape system according to the invention comprises
(i) a film D of a reactive heat-activatable adhesive, where the reactive heat-activatable adhesive contains at least one electrolyte; and
(ii) a primer composition which is intended to form a separate layer and contains at least the following constituents:
(a) at least one thermoplastic polyurethane; and
(b) at least one organosilane.

The method according to the invention for producing a bonded composite comprises at least the following method steps:
i. providing an electrically conductive substrate A or an electrically conductive carrier layer T;
ii. providing the film D of a reactive heat-activatable adhesive, where the reactive heat-activatable adhesive contains at least one electrolyte;
iii. providing the primer composition, where the primer composition contains at least the following constituents:
   (a) at least one thermoplastic polyurethane; and
   (b) at least one organosilane;
iv. contacting a surface of the substrate A or a surface of carrier layer T with a first surface of film D;
v. where the contacting between substrate A and the first surface of film D or carrier layer T and the first surface of film D is preceded by applying of the primer composition from step iii. as layer P; and
x. activating film D by supplying heat at 40° C. or more and by application of a pressing pressure of more than 1 bar.

It has been found that, surprisingly, with the adhesive tape system according to the invention, the method according to the invention produces a bonded composite having improved bond strengths and shock resistance compared to the prior art, but at the same time is electrically debondable by applying a voltage. The electrical debonding is enabled by the electrolyte present in the adhesive. The method of electrically debonding the composite, in spite of the high original bond strengths, allows removal of the adhesive with very little application of force and without residues of the adhesive film. It has been found that this is only possible with the specified primer composition and not with other primer compositions from the prior art. At the same time, it has been found that, in the production of the bonded composite, the activation temperature for the reactive heat-activatable adhesive can be lowered and bond strengths are achieved that are just as high as achieved in the prior art, but at higher temperatures.

This enables the use of the adhesive tape system and of the method for producing a bonded composite using the adhesive tape system or of the bonded composite and the method of electrical debonding in sensitive applications involving thermally sensitive substrates.

Adhesive tapes and methods of electrical redetachment or of electrical reduction of adhesion strength are known in principle in the prior art. For instance, as set out above, EP 3 031 875 B1 discloses such an electrical method. The electrically detachable adhesive here is acrylate-based.

However, it was not foreseeable in the present context that even a heat-activatable adhesive with which adhesion strengths to different substrates are comparatively high can be electrically detached after bonding, and, surprisingly, with use of the primer specified in detail, there is simultaneously an improvement in bond strength prior to debonding and it is even possible, as described, to lower the activation temperature of the reactive adhesive.

The invention is described in detail hereinafter.

The expression “at least one” or the equivalent “one or more” refers, in a manner usual in the sector, to the chemical nature of the entity in question and not to the amount of substance thereof. It will be clear to the skilled person that the expression “an electrolyte” therefore refers to a multitude of electrolyte molecules.

As usual, “% by weight” here stands for percent by weight. This applies to all details given.

In the context of the present invention, an “adhesive tape system” means a functional unit consisting of several, mutually coordinated components which together achieve a specific technical effect—in particular improved bonding and electrical detachability. The adhesive tape system according to the invention always comprises the film D of a reactive heat-activatable adhesive and a primer composition. It is essential that the primer composition is provided within this system for formation of an independent separate layer arranged in the application between film D and a substrate to be bonded or a carrier layer.

### Substrate A or Carrier Layer T (Step i.)

In step i., an electrically conductive substrate A or an electrically conductive carrier layer T is provided.

The bonded composite with improved bond strength coupled with very good electrical detachability is thus produced at least between an electrically conductive substrate A and a film D of a reactive heat-activatable adhesive after appropriate activation, or at least between an electrically conductive carrier layer T and a film D of a reactive heat-activatable adhesive after appropriate activation.

In the context of the present invention, a distinction is made between substrate and carrier layer. A substrate means a component of an article or an article that is to be provided with an adhesive bond using the reactive adhesive film.

A carrier layer means a further layer of an adhesive tape in addition to the film D of the reactive adhesive which additionally, as known to the person skilled in the art of adhesive tapes, has an adhesive-supporting, spatially stabilizing and hence carrying function.

The substrates and carrier layers are described in detail below in the description relating to the possible structures of the bonded composite.

### Film D of a Reactive Heat-Activatable Adhesive (Step ii) and Activation of the Adhesive (Step x.)

In step ii, a film D composed of a reactive heat-activatable adhesive is provided. Film D is part of the adhesive tape system according to the invention.

The film of the adhesive is a layer of any geometry, for example circular, square, rectangular in any other form, or in any other geometry. The film is especially in elongate sheet form. An elongate sheet means an object, the length of which (extent in x direction) is many times greater than its width (extent in y direction), the width remaining approximately and preferably exactly the same over the entire length.

The reactive heat-activatable adhesive is preferably non-adhesive before activation. In order to correctly represent this state, the layer of the adhesive is referred to as film. Where an adhesive film or adhesive tape is nevertheless discussed in the context of this invention, what is being emphasized in particular is that the film can achieve an adhesive effect, in particular by the activation.

Before use in the method according to the invention, the film can thus be provided in particular as activatable adhesive tape. The adhesive tape, particularly in elongate sheet form, can be produced either in the form of a roll, i.e. rolled up on itself in the form of an Archimedean spiral, or as adhesive strips, as obtained for example in the form of blanks or die cuts. The general expression “film” or “adhesive film”, “adhesive tape”, and synonymously “adhesive strip”, for the purposes of this invention encompasses all sheetlike structures, such as films or film portions extended in two dimensions, tapes having extended length and limited width, tape portions and the like, and lastly also die-cuts or labels.

In addition to the longitudinal extent (x direction) and lateral extent (y direction), the adhesive tape also has a thickness (z direction) running perpendicular to the two extents, the lateral extent and longitudinal extent being many times greater than the thickness. The thickness is very substantially the same, preferably exactly the same within tolerances, over the entire areal extent of the adhesive tapes determined by their length and width.

The reactive heat-activatable adhesive contains at least one electrolyte.

An “electrolyte”, according to the general understanding of those skilled in the art, is understood in the present case as meaning a chemical compound that is dissociated into ions in the solid, liquid or dissolved state and that moves in a directed manner under the influence of an electric field.

The electrolyte is selected from the group consisting of ionic liquids and metal salts, ionic liquids being particularly preferred.

In particular, it is possible by means of one or more ionic liquids as electrolyte to easily redetach the adhesive tape without this adversely affecting the adhesive properties of the adhesive tape. Ionic liquids have the advantage here of being easily and homogeneously dispersible in the polymer matrix of adhesives, and the redetachment works more quickly than with other electrolytes. Furthermore, the constituents of ionic liquids are nonvolatile, in particular at room temperature. Ionic liquids are moreover relatively heat-resistant and non-flammable, as well as chemically relatively stable.

Ionic liquids are therefore particularly well suited as electrolytes in the context of the separation method/method for electrical debonding of the invention. When a voltage is applied, the adhesion strength of the ionic liquid-containing adhesive to at least one substrate is lowered, which achieves an adhesive split between the adhesive and the bonded surface. All ionic liquids are in principle suitable in the context of the present invention.

Ionic liquids in the context of the present invention are salts which are liquid at 100° C. and preferably at room temperature, i.e., 23° C. Ionic liquids accordingly contain anions and cations. Ionic liquids which are liquid at 100° C. but solid at 23° C. are rendered processible preferably by suitable method steps, such as in particular and for example by dissolution in a solvent.

Ionic liquids which are liquid at 23° C. are preferred.

The ionic liquids used with preference in the context of the present invention comprise at least one anion and at least one cation. It is also conceivable here that the ionic liquid comprises two or more types of anion and/or two or more types of cation. It is also conceivable that two or more different ionic liquids are added to the adhesive or that the adhesive then comprises two or more different ionic liquids.

Preferably, the anion of the ionic liquid is selected from the group consisting of:

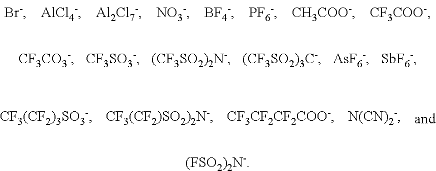

The anion is more preferably selected from (CF₃SO₂)₂N⁻ and (FSO₂)₂N⁻. By applying a voltage, this achieves a particularly high reduction in adhesion strength and hence particularly good electrical detachability. In particular, (re)detachment is particularly quick and no residues are left.

Preferably, the cation of the ionic liquid is selected from the group consisting of imidazolium-based cations, pyridinium-based cations, pyrrolidinium-based cations, and ammonium-based cations.

Particularly preferably, the cation is selected from the group consisting of imidazolium-based cations. By applying a voltage, this achieves a particularly high reduction in adhesion strength and hence particularly good electrical detachability. In particular, (re)detachment is particularly quick and no residues are left.

Even more preferably, the cation is selected from the group consisting of 1-ethyl-3-methylimidazolium and 1-butyl-3-methylimidazolium.

The electrolyte is more preferably selected from the group consisting of the ionic liquids 1-ethyl-3-methylimidazolium bis(trifluoromethylsulfonyl)imide (EMIM-TFSI) and 1-ethyl-3-methylimidazolium bis(fluorosulfonyl)imide (EMIM-FSI). By applying a voltage, this achieves a particularly high reduction in adhesion strength and hence particularly good electrical detachability. In particular, (re)detachment is particularly quick and no residues are left.

It is preferable that the reactive heat-activatable adhesive of film D contains 1% to 10% by weight, more preferably 2% to 8% by weight, of electrolytes, preferably ionic liquids, based on the total weight of the adhesive without solvent.

With such a preferred or particularly preferred amount of electrolytes, and of ionic liquids in particular, comparatively rapid electrical detachment is made possible, while at the same time there is no adverse impairment prior to detachment of the adhesion of the adhesive layer to the adjacent layers, in particular at least one substrate or at least one carrier layer.

The material of the adhesive layer D is a reactive heat-activatable adhesive.

Heat-activatable adhesives can be divided fundamentally into two categories, these being purely physically heat-activatable adhesives and reactive heat-activatable adhesives.

### Physically Heat-Activatable Adhesives

These adhesives, also referred to as “hotmelt adhesives”, have little or no self-adhesiveness at room temperature. The adhesive becomes activated only with the heat and thereby acquires self-stickiness. A correspondingly high glass transition temperature of the adhesive is responsible for this, so that the activation temperature for achieving sufficient tack—usually several tens to a hundred degrees Celsius—is above room temperature. Owing to the self-adhesive properties, an adhesive effect occurs before the adhesive has set. After the joining of the adherends, the physically heat-activatable adhesive sets physically during cooling with solidification, so that the adhesive effect is maintained in the cooled state and has developed the actual strength of adhesion forces there.

The more heat, pressure and/or time is applied during bonding, the stronger the bond between the two materials to be bonded will usually become. With this, maximum bond strengths can be achieved regularly under technically easy processing conditions. The physical melting results in a high bond strength and thus adhesive effect. The compounds are therefore purely physically heat-activatable adhesives.

### Reactive Heat-Activatable Adhesives

Reactive heat-activatable adhesives (also referred to as “reactive adhesives”) are polymer systems which have functional groups in such a way that a chemical reaction takes place when heat is supplied, with the adhesive setting chemically and thus giving rise to relatively high internal strength. It may likewise be advantageous to design the reactive adhesives in such a way that they become softer and/or more fluid at elevated temperature, in order to conform optimally to the bonded composite; this is achieved, in particular and preferably, by a thermoplastic component. Owing to the stated chemical reaction and also the physical melting, a high bond strength and thus adhesive effect is achieved.

As can be deduced from the term “heat-activatable”, the activation which leads to the adhesive bonding effect is accomplished by supply of heat. This means that at room temperature, more particularly at 23° C., these adhesives are not activated, i.e., the effect that leads to permanent bonding is not triggered.

Accordingly, the method according to the invention for producing the bonded composite comprises step x. activating film D by supply of heat at 40° C. or more, among other means. The activation is preferably effected at a temperature of 40 to 120° C., more preferably 50 to 120° C., most preferably at a temperature of 50 to 75° C. The specified temperatures at which the activation is effected relate in particular to the temperatures in the adhesive to be activated. These temperatures are achieved via appropriate supply of heat.

It has been found that, surprisingly, very high bond strengths can be achieved by the method according to the invention even at 40 to 75° C., in particular 50 to 75° C., which means that it is suitable for thermally sensitive substrates and possibly carrier materials.

The duration of activation is preferably 10 seconds to 10 minutes, more preferably 10 seconds to 8 minutes. In preferred embodiments of the invention, the duration is 40 seconds to 8 minutes. In preferred embodiments of the invention, the duration is 30 seconds to 6 minutes, more preferably 60 seconds to 3 minutes. With these comparatively short activation times, quick and very stable bonding is achieved.

In this case, at a high activation temperature in the stated temperature ranges, a correspondingly short activation duration is preferably selected, while at low temperatures a correspondingly longer activation duration is selected. This also depends in particular on the bond strength that is to be achieved.

The activation is additionally effected with application of a pressure, also called pressing pressure. The pressing pressure is more than 1 bar and preferably from 1 to 15 bar, more preferably 2 to 12 bar.

The activation is effected in particular and with preference by applying a heating press to the bond to be bonded. This provides the desired input of heat and pressure to the overall system.

Before activation, in particular in the case of a dried and thus comparatively rigid film D, there is preferably what is called a pre-lamination in order to achieve optimal wetting of the substrate or the surface to be bonded with the heat-activatable adhesive. This is done in particular and for example by preheating the substrates to be bonded.

Preferably, for this purpose, the substrates to be bonded are heated to a temperature of 50 up to 70° C. The application of the adhesive layer to the respective substrate is preferably carried out at a pressure of 1 to 3 bar for a duration of 5 to 20 seconds. This ensures a uniform flow of the adhesive onto the substrate prior to activation.

In the case of bonding to a conductive carrier layer, in particular and with preference, heating of the carrier layer is conducted when the provided film D is already dried, in order to facilitate or ensure adaptation here too.

In the context of the present invention, the primer composition is preferably applied beforehand to the substrate or the carrier layer in the preheating steps described.

The reactive heat-activatable adhesive preferably contains at least one thermoplastic elastomer. The thermoplastic elastomer may comprise in principle all thermoplastic polymers that are suitable for use in heat-activatable adhesives, such as more particularly polyurethanes, polyesters, and polyamides. With particular preference, the thermoplastic elastomer is thermoplastic polyurethane (TPU). The polyurethane is preferably a semicrystalline polyurethane.

Suitable polyurethanes are, for example, commercially available products from the IROSTIC® family from Huntsman.

Preferably, the heat-activatable adhesive contains 65% to 98% by weight, more preferably 75% to 96% by weight, most preferably 80% to 94% by weight, of thermoplastic elastomers, in particular thermoplastic polyurethanes, preferably semicrystalline, preferably hydroxy-terminated, thermoplastic polyurethanes, based on the total weight of the adhesive without solvent.

Reactive heat-activatable adhesives may be based on different polymers and crosslinking chemicals and mechanisms.

The thermoplastic elastomer preferably comprises functional groups that can react with isocyanate. The reactive heat-activatable adhesive of film D here contains an isocyanate-containing compound as crosslinker.

Here too, a preferred thermoplastic elastomer is at least one thermoplastic polyurethane, and preferably in turn semicrystalline thermoplastic polyurethane.

The functional groups which can react with isocyanate are, for example and in particular, hydroxyl groups, amino groups or urethane groups. In particularly preferred embodiments of the invention, the functional groups are hydroxyl groups.

Surprisingly, such a reactive heat-activatable adhesive has particularly good electrical redetachability after bonding, with the bond strength being extremely reduced by application of a voltage. In addition, the separation takes place cleanly; this means either that residues of the adhesive are not present on the substrate or that they can be removed easily, for example manually.

Surprisingly, it has also been found that depending on the type and area of the residues of the adhesive, it is also possible to reuse them without removing them and thus to re-bond the substrate via the residues, which in turn brings environmental advantages.

In preferred embodiments of the invention, diisocyanate compounds are used as isocyanate-containing compound, in particular tolylene diisocyanate compounds (TDI compounds), for example TDI dimers, available for example as Dancure® 999 (1,3-bis(3-isocyanato-4-methylphenyl)-1,3-diazetidine-2,4-dione; in solid form), and/or isophorone diisocyanates (IPDI).

Preferably, the heat-activatable adhesive contains 1% to 25% by weight, more preferably 2% to 15% by weight, very advantageously 4% to 12% by weight, of isocyanate-containing compounds, based on the total weight of the adhesive.

Preferably, the reactive heat-activatable adhesive is based on an organic solvent and is thus a solvent-based adhesive. What is meant by solvent-based in the context of the present invention is that one or more organic solvents are used in the mixing of the constituents in the production of the adhesive—and if required by their viscosities—but no water or any other inorganic solvent is used.

The organic solvent serves the purpose of dissolving the polymer used in the adhesive, in particular thermoplastic elastomers, for example thermoplastic polyurethane. The organic solvent used is preferably anhydrous. The organic solvent is selected according to preferred and illustrative embodiments from the group consisting of methyl ethyl ketone (MEK), butanone, acetone, toluene, ethyl acetate and mixtures thereof.

With preference and by way of example, the solvent is anhydrous methyl ethyl ketone (MEK). However, there is no intention to limit the invention to the illustrative solvents mentioned. It will be apparent that other suitable solvents are those in which the polymer used, in particular thermoplastic elastomers, for example thermoplastic polyurethane, is soluble. Therefore, the organic solvent is selected from the group of solvents in which the thermoplastic polyurethane is soluble.

In advantageous embodiments of the invention, the reactive heat-activatable adhesive of film D preferably additionally comprises a compound from the group of epoxides and/or epoxy compounds. Preferred are mono-, di-, tri- or polyfunctional epoxides and/or epoxy-compounds.

These include, for example, compounds viscous/liquid at 23° C., such as N,N,N′,N′-tetrakis(2,3-epoxypropyl)-m-xylene-a,a′-diamine and/or 7-oxabicyclo[4.1.0]hept-3-ylmethyl 7-oxabicyclo[4.1.0]heptane-3-carboxylate and/or compounds with a melting/softening point above 23° C. (so-called epoxy resins) such as Epiclon® N-673. Suitable examples are, in particular, bisphenol F epoxy resins, which are available under the series with the trade name Epiclon®, for example.

The adhesive of film D may further contain customary additives, such as compatibilizers, emulsifiers, fillers, pigments, amines and ageing inhibitors.

Compatibilizers used with preference are low molecular mass polyethers, such as polyethylene glycol (PEG) and/or polypropylene glycol (PPG), polyamines, polyvinylpyrrolidones or aliphatic polyesters which are homogeneously miscible with the adhesive.

The reactive heat-activatable adhesive is produced by mixing the constituents, in particular as described, using organic solvents for dissolving individual components, in particular the thermoplastic elastomer.

Thereafter, the mass is spread—in particular from solution—as a layer with defined layer thickness and hence in the form of a film and then dried, with evaporation of the solvent.

Primer Composition and Primer Layer P (Step iii)

The adhesive tape system according to the invention comprises a primer composition which is provided for formation of a separate layer.

The term “primer” is known to the person skilled in the art in association with adhesive bonds. In the context of the invention, the term “primer” means in particular a primer applied between two layers of material, which is capable (either on a chemical or physical basis) of interacting with the two layers of material and of enabling adhesion thereof with one another.

The primer is generally considered to be a formulated product (generally contains more than one component) which is applied from the liquid phase by appropriate methods (dipping into the surface, painting, spraying, etc.). According to this definition, the primer should not only have the ability to enable adhesion but also to form an even primer layer on the surface of the substrate by adjusting its viscosity, its wetting properties, its drying speed, etc.

In the context of the present invention, the composition of the primer in particular is considered and described with regard to its constituents and hence the “primer composition”.

By virtue of the primer composition used in accordance with the invention containing the combination of (a) at least one thermoplastic polyurethane and (b) at least one organosilane, a bonded composite of at least one substrate or at least one carrier layer and the activated adhesive film using the primer composition between the substrate or carrier layer and the adhesive film surprisingly has improved bond strengths. At the same time, the activation temperature of the adhesive film can be distinctly reduced.

The primer composition used in accordance with the invention thus enables the production of a stronger adhesive bond even in the case of temperature-sensitive substrates.

The (a) thermoplastic polyurethane present in accordance with the invention preferably has no free isocyanate groups. The content of free isocyanate groups is determined in particular by IR spectroscopy. Polyurethanes with free isocyanate groups, especially obtained as polyurethanes with terminal isocyanate groups, owing to an excess of di- and/or polyisocyanates during the production of the polyurethane, are moisture-curing and hence cure on contact with humidity.

The (a) thermoplastic polyurethane present in accordance with the invention is preferably hydroxy group-terminated and thus preferably has terminal OH groups. Such a polyurethane is not moisture-curing and hence does not react with humidity. It is therefore of particularly good suitability for production of the primer composition according to the invention.

In preferred embodiments, the polyurethane is the chemical reaction product of a1) at least one diol and/or polyol, and a2) at least one di- and/or polyisocyanate, where an excess of a1) diols and/or polyols over the a2) di- and/or polyisocyanates is preferably chosen in the reaction.

Useful diols/polyols are in principle all known aliphatic or aromatic di- or poly-hydroxy-functionalized substances, in particular all polyester diols/polyols, including all polycaprolactone diols/polyols, all polyester carbonate diols/polyols, all polyether diols/polyols and all polybutadiene diols/polyols, and also related substances or derivatives thereof. In addition, what are called chain extenders and/or crosslinkers are also useful, which means di- or poly-hydroxy-functionalized substances are understood that are not poly compounds.

Polyester diols/polyols usable in accordance with the invention are polyesters with terminally bound hydroxyl groups.

Polyester diols have two terminally bound hydroxyl groups, i.e. are difunctional. In the case of polyester polyols, the number of terminally bound hydroxyl groups is not clearly defined. There may be two or more hydroxyl groups per molecule. In this document, polyester polyols mean those having more than two hydroxyl groups per molecule. Polyester diols/polyols usable in accordance with the invention are generally obtained by polycondensation from diols/polyols and di-/polycarboxylic acids or, in the case of polycaprolactone polyols, by ring-opening polymerization of ε-caprolactone and a di- or polyfunctional starter molecule.

Polyester carbonate diols are di-hydroxy-functionalized polyesters, the molecular chain of which also includes at least one carboxylic acid ester group. They can be obtained, for example, by poly reaction of a diol, a dicarboxylic acid and dimethyl carbonate (DMC) or diphenyl carbonate (DPC). In the case of polyester carbonate polyols, the number of terminally bound hydroxyl groups is not clearly defined. There may be two or more hydroxyl groups per molecule. In this document, polyester carbonate polyols mean those having more than two hydroxyl groups per molecule.

Polyether diols/polyols usable in accordance with the invention are polyethers having terminally bound hydroxyl groups. Polyether diols have two terminally bound hydroxyl groups, and so they are difunctional. For polyether polyols, the number of terminally bound hydroxyl groups is not clearly defined. There may be two or more hydroxyl groups per molecule. In this document, polyether polyols mean those having more than two hydroxyl groups per molecule. Polyether diols/polyols usable in accordance with the invention are produced primarily from ethylene oxide, propylene oxide or tetrahydrofuran by ring-opening polymerization or copolymerization using a starter molecule that determines the functionality.

Polybutadiene diols are di-hydroxy-functionalized polybutadienes produced from butadiene in an anionic polymerization method. Known commercial products are, for example, the Krasol® products from Cray Valley. Polybutadiene polyols may bear two or more hydroxyl groups per molecule. In this document, polybutadiene polyols are those having more than two hydroxyl groups per molecule. They are produced from butadiene in a free-radical polymerization method. Well-known commercial products are, for example, the Poly Bd® products from Cray Valley.

Examples of chain extenders are ethane-1,2-diol, propane-1,2-diol, propane-1,3-diol, 2-methylpropane-1,3-diol, butane-1,4-diol, butane-2,3-diol, propylene glycol, dipropylene glycol, cyclohexane-1,4-dimethanol or 2-ethylhexane-1,3-diol.

Examples of crosslinkers are glycerol, trimethylolpropane or butane-1,2,4-triol.

In particularly advantageous embodiments of the invention, the a1) at least one diol and/or polyol is selected from the group consisting of polyester diols, polyester polyols, polyester carbonate diols and polyester carbonate polyols, with particular preference in turn for polyester diols and/or polyester carbonate diols.

a2) Di- and/or polyisocyanates usable in accordance with the invention are all known aliphatic and/or aromatic diisocyanates and/or polyisocyanates. Diisocyanates bear two isocyanate groups per molecule, and so they are difunctional. Polyisocyanates bear two or more isocyanate groups per molecule. In this document, polyisocyanates mean those having more than two isocyanate groups per molecule.

Examples of useful di- and/or polyisocyanates are 1-isocyanatomethyl-3-isocyanato-1,5,5-trimethylcyclohexane (isophorone diisocyanate, IPDI), hexane 1,6-diisocyanate (hexamethylene diisocyanate, HDI), dicyclohexylmethane 4,4′-diisocyanate (H12MDI), tolylene diisocyanate, diphenylmethane 4,4′-diisocyanate (4,4′ MDI) and/or m-tetramethylxylene diisocyanate (TMXDI), mixtures of the said isocyanates or chemically related isocyanates, for example dimerized, trimerized or polymerized types containing, for example, urea, uretdione or isocyanurate groups.

Particular preference is given to using difunctional starting materials, i.e. diols and diisocyanates.

In advantageous embodiments, the diisocyanate a2) used is diphenylmethane 4,4′-diisocyanate (4,4′-MDI) and/or hexane 1,6-diisocyanate (hexamethylene diisocyanate, HDI), more preferably diphenylmethane 4,4′-diisocyanate (4,4′-MDI).

According to advantageous embodiments, a polyester polyurethane is used as thermoplastic polyurethane a). In this regard, the diol component obtained at first is preferably a reaction product of a diol with a carboxylic acid, in particular a dicarboxylic acid, as a macrodiol. For example, the diol a1) used is hexane-1,6-diol and the dicarboxylic acid adipic acid.

In order to accelerate the reaction of the diols/polyols with the di-/polyisocyanates, one or more catalysts known to the person skilled in the art may be used, for example tertiary amines, organobismuth or organotin compounds, to name just a few.

It is very advantageously possible to use bismuth- and carbon-containing catalysts, preferably a bismuth carboxylate or a bismuth carboxylate derivative, in particular bismuth trisneodecanoate, CAS No.: 34364-26-6. The concentration of the catalyst is matched to the diols/polyols and di-/polyisocyanates used. In general, it is between 0.01% by weight and 0.5% by weight of the polyurethane to be produced.

The thermoplastic polyurethane (a) present in accordance with the invention is preferably a semicrystalline thermoplastic polyurethane. This achieves the object underlying the invention particularly efficiently.

The thermoplastic polyurethane (a) present in accordance with the invention preferably has a storage modulus G′, determined by DMA, of more than 1 MPa. More preferably, the storage modulus G′ is more than 5 MPa, preferably in turn more than 15 MPa, in particular up to 100 MPa, more preferably up to 50 MPa.

The storage modulus G′ is determined by means of dynamic-mechanical analysis (DMA) in accordance with DIN EN ISO 6721-1:2019-09.

The measurement is performed with a TA HR20 (TA Instruments) rheometer. The granular material, about 0.1 g, is placed on the round, lower punch of the rheometer. The stamping temperature is brought above the melting point of the material to be examined and the material is thus melted. A flat metal punch is used to flatten out the molten material. The method is repeated 3 to 4 times until the layer thickness attained is about 1 mm. The upper punch is then brought into contact with the polymer film. Material leaking from the join is removed.

The oven doors surrounding the parallel plates and shafts of the rheometer are closed and the temperature is raised to 100° C. and held for 5 minutes to relieve any residual stresses. The axial force is then set to 0 in order to maintain contact between the material and the plates. The temperature was set to −50° C. and then increased from −50° C. to 200° C. at a rate of 5° C./min, while the parallel plates oscillated at a frequency of 1° Hz and an initial strain amplitude of 0.15%. The strain was increased by 50% of the current value as soon as the measured torque dropped below 1 g-cm, with a maximum permissible strain amplitude of 10%.

For example, a suitable thermoplastic polyester polyurethane is available under the Laricol 1460 trade name from Coim. A further suitable thermoplastic polyester polyurethane is available under the IROSTIC® S-6558-06 trade name from Huntsman.

The primer composition used in accordance with the invention, in preferred embodiments of the adhesive tape system, in particular in the process for producing the bonded composite, i.e. when applying the primer composition to at least one surface of a substrate to be bonded and/or a carrier layer to be bonded and/or film of the reactive adhesive, contains at least one solvent, in particular at least one organic solvent. The solvent in the primer composition serves the purpose of dissolving the thermoplastic polyurethane used in the primer composition. Preference is thus given to an adhesive tape system or a process for producing a bonded composite, wherein the primer composition provided for the formation of a separate layer, or the primer composition provided in step iii and applied in step v., contains at least one organic solvent, wherein the thermoplastic polyurethane (a) of the primer composition is soluble in the solvent.

With preference and by way of example, it is an anhydrous mixture of 80% by weight of ethyl acetate and 20% by weight of methyl ethyl ketone (MEK), or 100% methyl ethyl ketone or acetone. However, there is no intention to restrict the invention to these illustrative solvents. It will be apparent that other solvents in which the thermoplastic polyurethane is soluble are also suitable.

The solvent evaporates in particular after the primer has been applied, such that the primer or applied primer layer P is dried.

In the context of the present invention, the undried primer composition is therefore considered on the one hand, and the dried primer composition that results from the evaporation of solvent and water, in particular from the applied primer layer P, on the other.

In advantageous embodiments of the invention, the primer composition before drying contains 2% to 10% by weight, preferably 3% to 8% by weight, more preferably 3% to 5% by weight, based on the total weight of the undried primer composition, of the at least one thermoplastic polyurethane (a).

Preferably, the dried primer composition contains 70% to 90% by weight, more preferably 70% to 85% by weight, most preferably 75% to 85% by weight, of the at least one thermoplastic polyurethane (a), based in each case on the total weight of the dried primer composition.

If two or more different thermoplastic polyurethanes are present as constituent (a), the stated amounts relate to the total amount of thermoplastic polyurethane.

These stated amounts result in particularly advantageous properties, in particular a particularly high bond strength of the adhesive bond produced with the primer composition in the bonded composite.

According to the invention, the primer composition (b) contains at least one organosilane.

The organosilane may in principle be any compound of the R—Si(R¹R²R³) type which is known to the skilled person, where R represents an organic radical which may contain heteroatoms and R¹, R² and R³ represent the remaining radicals on the silicon atom, which are preferably selected from alkoxy groups and alkyl groups. The R¹, R² and R³ radicals may be the same or different independently of one another.

More preferably, R¹, R² and R³ are alkoxy groups, and preferably in turn selected from methoxy and ethoxy groups.

In advantageous embodiments of the invention, the organosilane (b) is selected from the group consisting of
trialkoxysilylalkyl succinic anhydrides,
trialkoxyphenylsilanes,
(3-mercaptopropyl)trialkoxysilanes,
(3-aminopropyl)alkoxysilanes,
3-(2-aminoethylamino)propyltrialkoxysilanes,
vinyltrialkoxysilanes, and
(3-glycidyloxypropyl)trialkoxysilanes.

In particularly advantageous embodiments of the invention, the organosilane (b) is selected from the group consisting of
trialkoxysilylalkyl succinic anhydrides,
trialkoxyphenylsilanes,
(3-mercaptopropyl)trialkoxysilanes,
vinyltrialkoxysilanes, and
(3-glycidyloxypropyl)trialkoxysilanes.

Preferred (3-glycidyloxypropyl)trialkoxysilanes are (3-glycidyloxypropyl)trimethoxysilane and/or (3-glycidyloxypropyl)triethoxysilane.

The organosilane (b) present in the primer composition is most preferably at least one trialkoxysilylalkyl succinic anhydride.

This surprisingly results in improved chemical stability and also very good bond strengths before and after storage under warm and humid conditions.

The alkyl moiety of the trialkoxysilylalkyl succinic anhydride is preferably a linear alkylene group having 1 to 10 carbon atoms, further preferably 3 to 8 carbon atoms. A propylene group is particularly preferred. Thus, the silane is preferably a trialkoxysilylpropyl succinic anhydride.

Preferably, the trialkoxy groups within a molecule are the same. Preferably, the alkoxy groups of the trialkoxysilylalkyl succinic anhydride are selected from methoxy group and ethoxy groups.

In particularly advantageous embodiments of the invention, the primer contains (3-triethoxysilylpropyl)succinic anhydride as trialkoxysilylalkyl succinic anhydride and hence as organosilane (b).

In advantageous embodiments of the invention, the amount of organosilanes (b) present in the undried primer composition is 0.5% to 5.0% by weight, preferably 0.5% to 3.0% by weight, more preferably 0.5% to 1.5% by weight, based on the total weight of the undried primer composition.

In advantageous embodiments of the invention, the amount of organosilanes (b) present in the dried primer composition is 10% to 30% by weight, preferably 15% to 30% by weight, more preferably 15% to 25% by weight, based on the total weight of the dried primer composition. In advantageous embodiments of the invention, the ratio of the total amount of thermoplastic polyurethane (a) to the total amount of organosilanes (b), in particular (3-triethoxysilylpropyl)succinic anhydride, is from 3:1 to 5:1, more preferably 3.5:1 to 4.5:1, even more preferably 3.75:1 to 4.25:1, in particular 4:1.

Organic solvents and water are not included in this ratio.

A particularly preferred dried primer composition used contains, based on the total weight of the dried primer composition:
(a) 75% to 85% by weight of at least one thermoplastic polyurethane
(b) 15% to 25% by weight of at least one organosilane.

Preferably, the sum total of the amounts of constituents (a) and (b) is 98% to 100% by weight, in particular 100% by weight. If the total is less than 100% by weight, in particular, unevaporated or as yet unevaporated amounts of solvents are present.

The primer composition is produced in particular in that said constituents (a) and (b) are combined and mixed with one another. This involves combining the thermoplastic polyurethane and the organosilane as separate substances. In particular, they are not reacted with one another beforehand, such that, in particular, the production of the primer composition according to the invention does not involve any silane-functionalized polyurethane.

The constituents are mixed together in particular in at least one organic solvent.

In the context of the present invention, “solvents” mean solvents other than water, in particular organic solvents.

The primer composition is adjusted in particular and with preference by addition of organic solvent to a desired solids content, in particular with regard to a desired viscosity, such that it is adapted to the respective conditions on application for production of the adhesive bond of the bonded composite. In preferred embodiments, the total amount of organic solvents is 85% to 98% by weight, preferably 93% to 98% by weight, in particular and by way of example 95% by weight, based on the total weight of the undried primer composition.

The primer is preferably applied manually (e.g. by brushing or spraying) or by machine (e.g. by coating or printing). If the primer contains solvents and/or water, it is then dried.

The application of the primer composition to a surface, for example to a substrate, in particular a component, and/or an adhesive, thus results in particular and with preference in an initially undried primer layer with a particular layer thickness.

The primer is preferably applied by means of a printer, a dosing nozzle, a squeegee, a brush or a suitable rod.

In advantageous embodiments, the primer is applied with a guided dosing nozzle, for example “EV series automated dispensing systems” from Nordson EFD.

In further advantageous embodiments, the primer is applied with a printer.

Preferably, the primer is applied in a complete area (full area) of the substrate and/or the adhesive film or of the carrier layer and/or the adhesive film.

It is alternatively preferable to apply the primer at defined or arbitrary distances in individual regions, for example in a circular shape.

The layer thickness of the primer layer is determined by laser-optical methods (CLSM (confocal laser microscope, from Keyence)).

The adding of any further layer to this primer layer is then preceded, as already described in particular and with preference, by the drying of the primer layer, which results in a dried primer layer with correspondingly reduced layer thickness.

The primer layer P preferably has a layer thickness of 0.05 μm to 50 μm after drying, in particular 0.05 μm to 10 μm. According to advantageous embodiments, the primer layer P has a layer thickness of 0.5 to 5 μm after drying.

Primer Application and Contacting (Steps v. And iv.)

In the method according to the invention, in step iv., a surface of the substrate A is contacted with a first surface of the film D or a surface of the carrier layer T is contacted with a first surface of the film D. This can be done in principle by all methods known to the skilled person and with the aid of known devices and aids. This contacting creates the bonding face that makes the bonded composite.

However, it is essential to the invention that, in step v., the contacting is preceded by applying of the primer composition from step iii. as layer P between the surfaces to be contacted. In this case, the primer composition is applied either to the first surface of film D and/or the surface of substrate A or to the first surface of film D and/or the surface of carrier layer T. The primer composition can thus be applied to only one surface at a time or to both surfaces to be contacted.

After the primer has been applied, the primer layer P is preferably dried as described above if solvents are present in the primer composition applied. Depending on the layer thickness, the drying may be comparatively rapid.

The invention further provides a bonded composite produced by the method according to the invention.

The invention further provides a bonded composite comprising at least the layers in the sequence A-P-D or T-P-D as described above. Preferably, the bonded composite according to the invention comprises the layers in the sequence A-P-D-P-B, where A and B are electrically conductive substrates.

The bonded composite according to the invention is subject to all embodiments, in particular those for the method according to the invention.

### Further Layers of the Bonded Composite

The advantage achieved in accordance with the invention is manifested even in the bonding of a substrate or a carrier layer to the reactive heat-activatable adhesive film, since, as described, the specific primer composition has a surprising effect in this interface.

At the same time, the rest of the structure of the bonded composite may have any shapes and further layers. Thus, the precursor product that results from step v., prior to activation to give the bonded composite, can be combined with further substrates for production of different adhesive tape geometries. For example and with preference, the second surface of the film D may be provided with a protective liner and this surface may be bonded at a later juncture by activation to another carrier layer, another substrate or another adhesive.

More preferably, in the method of producing the bonded composite, two substrates, substrate A and substrate B, are bonded to one another.

In preferred embodiments of the invention, film D is a transfer adhesive tape, i.e. preferably has no further layers, and the second substrate B is likewise electrically conductive. In this case, the defined primer composition is more preferably also applied between the surface of the second substrate B and the second surface of the film D.

Thus, the method according to the invention, in particularly preferred embodiments, comprises at least the following steps:
i. providing an electrically conductive substrate A;
ii. providing a film D of a reactive heat-activatable adhesive, where the reactive heat-activatable adhesive contains at least one electrolyte;
iii. providing a primer composition, where the primer composition contains at least the following constituents:
   (a) at least one thermoplastic polyurethane; and
   (b) at least one organosilane;
iv. contacting a surface of the first substrate A with a first surface of film D;
v. where the contacting in step iv. between substrate A and the first surface of film D is preceded by applying of the primer composition from step iii. as layer P;
vi. providing an electrically conductive substrate B;
vii. contacting a surface of substrate B with a second surface of film D;
viii. where the contacting in step vii. between substrate B and the second surface of film D is preceded by applying of the primer composition from step iii. as layer P′;
x. activating film D by supplying heat at 40° C. or more and by application of a pressing pressure of more than 1 bar.

The bonded composite according to the invention that has thus been produced comprises the layers in the sequence A-P-D-P′-B.

Depending on the characteristics of the second substrate B, in particular if this is distinctly different from substrate A, the primer layer P′ can be dispensed with, which results in the A-P-D-B embodiment of the composite according to the invention.

Step viii. in the aforementioned method is thus optional.

In addition, it is also conceivable that, in the aforementioned embodiment, another primer is applied between D and B.

In further preferred embodiments, the film D is bonded to the first surface with an electrically conductive substrate A and to the second surface with an electrically conductive carrier layer T′. This makes it possible to apply a voltage to this carrier layer T′ later in the bonded composite, which is particularly advantageous if a further electrically non-conductive substrate is to be bonded to substrate A.

Depending on the characteristics of the carrier, the desired bond strength between film D and carrier layer and the chemical stability of the carrier layer to the primer, the primer can likewise be applied between film D and carrier layer T′.

In particularly preferred embodiments, the defined primer composition is also applied between the surface of the electrically conductive carrier layer T′ and the second surface of the film D.

The bonded composite according to the invention that has thus been produced comprises the layers in the sequence A-P-D-P′-T′. This advantageously achieves higher bond strengths between film D and electrically conductive carrier layer T′, for example and in particular in the case of metallized film as carrier layer T′.

However, if the adhesion strength of the adhesive of film D to the carrier layer T′ is sufficient, the structure without a second primer layer P′ and hence the structure A-P-D-T′ is conceivable and preferred.

In further preferred embodiments, film D is bonded to an electrically conductive carrier layer T. Such a bonded composite is usable flexibly and can be used in particular for bonding in further bonded composites of any construction, in particular for bonding an electrically conductive substrate and an electrically non-conductive substrate. According to the invention, the defined primer composition is applied here too between the film D and the electrically conductive carrier layer T.

Thus, the method according to the invention, in particularly preferred embodiments, comprises at least the following steps:
i. providing an electrically conductive carrier layer T;
ii. providing a film D of a reactive heat-activatable adhesive, where the reactive heat-activatable adhesive contains at least one electrolyte;
iii. providing a primer composition, where the primer composition contains at least the following constituents:
   (a) at least one thermoplastic polyurethane; and
   (b) at least one organosilane;
iv. contacting a surface of carrier layer T with a first surface of film D;
v. where the contacting between carrier layer T and the first surface of film D is preceded by applying of the primer composition from step iii. as layer P; and
x. activating film D by supplying heat at 40° C. or more and by application of a pressing pressure of more than 1 bar.

The bonded composite according to the invention that has thus been produced comprises the layers in the sequence T-P-D.

In further preferred embodiments, the composite A-P-D-P′-T′ or A-P-D-T′, before or after the heat activation according to step x., is bonded to a second electrically conductive substrate B via the surface area T′ still available of the carrier layer T′. It is preferable here that the carrier layer T′ does not project over any other layer, in particular any adjacent adhesive layer. This allows the composite of the layers to be easily processed collectively, in particular punched or otherwise converted to the desired shape. Such a structure thus has the advantage of simple producibility and, in addition, the possibility of adjusting the stability of the adhesive tape via the carrier layer(s). The voltage can then be applied in particular to the two electrically conductive substrates A and B.

In this case, the adhesive layer between T′ and B may likewise be a reactive heat-activatable film D′—containing at least one electrolyte—or a reactive heat-activatable adhesive layer C which does not contain an electrolyte and is rendered electrically conductive in some other way, for example by metal particles. Embodiments for electrically conductive adhesive layers C are listed below in the description.

Moreover, the adhesive layer C may be based on a non-heat-activatable electrically conductive adhesive, for example a reactive adhesive curable via UV or visible light at low temperatures, or, for example, a pressure-sensitive adhesive.

For example and with preference, a bonded composite A-P-D-P′-T′ or A-P-D-T′ is first produced by heat activation. A composite of C-B is created separately. By contacting T′ and C, and possibly subsequent activation of the adhesive C, for example by UV, the composite A-P-D-P′-T′-C-B or A-P-D-T′-C-B is produced.

In further preferred embodiments, the adhesive between T′ and B is likewise a reactive heat-activatable film D′. The composition of D′ may be in particular and with preference be the same as that of film D.

In the aforementioned embodiments too, the primer may also be applied between T′ and D′ and/or between D′ and B or between T′ and C and/or between C and B, in order to adjust the bond strengths at these interfaces.

The primer is preferably applied between substrates A/B and the respective adhesive film D/D′, which results, for example and with preference, in the construction A-P-D-T′-D′-P′-B.

In summary, preference is also given to those embodiments in which two electrically conductive substrates A and B are bonded to one another by means of an adhesive tape system according to the invention, wherein the adhesive tape system additionally includes at least one electrically conductive carrier layer and the described primer is applied in accordance with the invention between at least one surface of adhesive film D and the adjacent layer.

The method according to the invention for producing the bonded composite thus comprises, in preferred embodiments, the additional method steps resulting from the combination with the further layers mentioned depending on the type and embodiment.

The method according to the invention for production of the bonded composite A-P-D-T′-D′-P′-B therefore, proceeding from the production of A-P-D-T′, prior to activation, additionally comprises the steps, for example, of: providing a second reactive heat-activatable adhesive film D′ containing at least one electrolyte, providing a second electrically conductive substrate B, applying the primer composition between D′ and B to create the second primer layer P. The whole composite is then activated in step x.

In further preferred embodiments, film D is arranged between a first electrically conductive carrier layer T and a second electrically conductive carrier layer T′.

Depending on the characteristics of the carrier, the desired bond strength between film D and carrier layer T′ and the chemical stability of carrier layer T′ to the primer, the primer can likewise be applied between film D and carrier layer T′.

In particularly preferred embodiments, the defined primer composition is also applied between the surface of the electrically conductive carrier layer T′ and the second surface of the film D.

The bonded composite according to the invention that has thus been produced comprises the layers in the sequence T-P-D-P′-T′. This advantageously achieves higher bond strengths between film D and electrically conductive carrier layer T′, for example and in particular in the case of metallized film as carrier layer T′.

However, if the adhesion strength of the adhesive of film D to the carrier layer T′ is sufficient, the structure without a second primer layer P′ and hence the structure T-P-D-T′ is conceivable and preferred.

Such a bonded composite, in particular in the embodiments T-P-D-P′-T′ or T-P-D-T′, is usable flexibly and can be used in particular for bonding of two electrically non-conductive substrates.

Thus, the method according to the invention in preferred embodiments comprises at least the following steps:
i. providing an electrically conductive carrier layer T;
ii. providing a film D of a reactive heat-activatable adhesive, where the reactive heat-activatable adhesive contains at least one electrolyte;
iii. providing a primer composition, where the primer composition contains at least the following constituents:
   (a) at least one thermoplastic polyurethane; and
   (b) at least one organosilane;
iv. contacting a surface of carrier layer T with a first surface of film D;
v. where the contacting between carrier layer T and the first surface of film D is preceded by applying of the primer composition from step iii. as layer P; and
vi. providing an electrically conductive carrier layer T′;
vii. contacting a surface of carrier layer T′ with a second surface of film D;
viii. where the contacting in step vii. between carrier layer T′ and the second surface of film D is optionally preceded by applying of the primer composition from step iii. as layer P′;
x. activating film D by supplying heat at 40° C. or more and by application of a pressing pressure of more than 1 bar.

The bonded composite according to the invention that has thus been produced comprises the layers in the sequence T-P-D-P-T′.

In the case that, by an analogous method, a bonded composite of the invention with the layer sequence T-P-D-P′-B (or T-P-D-B) with B as electrically conductive substrate is created, this corresponds to the case A-P-D-P′-T′ (or A-D-P′-T′). Therefore, this embodiment of the invention is not specifically detailed.

In summary, the method according to the invention for production of the bonded composite of the invention, in preferred embodiments, comprises at least the following method steps:
i. providing an electrically conductive substrate A or an electrically conductive carrier layer T;
ii. providing a film D of a reactive heat-activatable adhesive, where the reactive heat-activatable adhesive contains at least one electrolyte;
iii. providing a primer composition, where the primer composition contains at least the following constituents:
   (a) at least one thermoplastic polyurethane; and
   (b) at least one organosilane;
iv. contacting a surface of the first substrate A or a surface of carrier layer T with a first surface of film D;
v. where the contacting in step iv. between substrate A and the first surface of film D or carrier layer T and the first surface of film D is preceded by applying of the primer composition from step iii. as layer P;
vi. providing an electrically conductive substrate B or an electrically conductive carrier layer T′;
vii. contacting a surface of substrate B or a surface of carrier layer T′ with a second surface of film D;
viii. where the contacting in step vii. between substrate B and the second surface of film D or carrier layer T′ and the second surface of film D is optionally preceded by applying of the primer composition from step iii. as layer P′;
x. activating film D by supplying heat at 40° C. or more and by application of a pressing pressure of more than 1 bar.

For the individual steps and features of all embodiments of the method, all the above embodiments, including all levels of preference and embodiments, are applicable directly (steps i. to v. and x.) or analogously (steps vi to viii.).

The chronological sequence of steps i. to iii. is arbitrary.

The chronological sequence of steps iv and v. is apparent from the wording.

Activation in step x. follows after the preceding steps.

If there is a carrier layer T and/or T′ in the overall structure of the adhesive tape in the bonded composite, and a substrate is bonded in each case on the opposite side from film D, preferably between carrier layer T or T′ and the substrate, a further adhesive layer C or if appropriate a second adhesive layer C′ is included.

Such a composite may, for example, have the structure S-C-T-P-D-P-T′-C′-S′, with S and S′ meaning electrically non-conductive substrates.

The carrier layers T or T and T′ in all the abovementioned embodiments are electrically conductive.

These layers are set out further in the text below. For the sake of simplicity, the term “electrically conductive carrier layer” or else just “carrier layer” is used. Depending on which one of the above embodiments, this refers to the carrier layer T or the carrier layers T and T′.

The carrier layers T and T′ are independent of one another and can be identical or different from one another. Preferably, the electrically conductive carrier layer comprises at least one metal. In preferred embodiments of the invention, the metal is selected from the group consisting of copper, nickel, zinc, tin, silver, gold, aluminium, iron, chromium, and alloys of said metals. Very preferably, the metal is selected from the group consisting of aluminium, tin, chromium-nickel, nickel-iron. Tin is very preferred.

Preferably, the electrically conductive carrier layer has a layer thickness, measured in z direction, i.e. parallel to the stacking direction of the layer arrangement, of from 10 nm (nanometres) to 50 μm (micrometres).

In preferred embodiments of the invention, the electrically conductive carrier layer includes a) at least one metal foil, for example an aluminium foil or nickel-iron foil, and/or b) at least one electrically conductive textile including at least one metal, preferably selected from the group consisting of copper and nickel, and/or c) one or more plies of at least one metal applied, preferably selected from the group consisting of copper, tin and aluminium, and/or d) at least one metal mesh and/or e) a metallized foil and hence a foil coated with metal, where the metal is preferably selected from the group consisting of aluminium, zinc, chromium-nickel and nickel-iron.

In principle, it is also conceivable here for the layer T to include a combination of two or more of the above options.

Metal foils, for example and with preference aluminium foils or nickel-iron foils, are known to those skilled in the art. The metal foil preferably has a layer thickness, measured in the z direction, i.e. parallel to stacking direction of the layer arrangement, of from 5 to 50 μm, more preferably from 10 to 30 μm.

Electrically conductive textiles are known to the skilled person, in particular by the expression “conductive mesh”. This is a textile fabric, for example one made of PET (polyethylene terephthalate), that is coated with a metal, for example with copper and/or nickel, this being how the electrical conductivity of the fabric is produced.

Those skilled in the art are likewise aware that metals can undergo direct application, for example vapour deposition, as a monolayer or multilayer onto surfaces such as in this case the surface of an adhesive layer. In the context of the present invention, the electrically conductive carrier layer can be provided by vapour deposition of metal onto film D or adhesive layer C or adhesive layer C′.

In the case of metal applied as a carrier layer, it is preferable in advantageous embodiments that this carrier layer protrudes laterally in at least one direction of extension of the layer plane over just one adjacent adhesive layer, the respective other adhesive layer serving as a mechanical support for this metal layer. The metal layer in this case has no actual carrier function. Instead, the other adhesive layer serves as carrier for the metal layer. For the sake of simplicity, the term carrier layer is retained for the metal layer in these embodiments too. Preferably, the layer thickness of layer T is in this case greater than or equal to 10 nm (nanometres), preferably 50 to 200 nm.

However, it is also conceivable and preferable that none of the layers project beyond any other layer. This allows the composite of the layers to be easily processed collectively, in particular punched or otherwise converted to the desired shape. It is conceivable and preferable here too that two electrically conductive substrates A and B are bonded and the voltage is applied to these substrates.

In addition, those skilled in the art are familiar with metal grids of varying dimensions. Metal grids having suitable layer thicknesses can be produced for example through a laid scrim of appropriately fine metal threads or by die-cutting at least one foil of appropriate layer thickness.

In the case of a metal-coated film, an electrically non-conductive film in particular is coated with metal in order to make it electrically conductive. The metal is preferably selected from the group consisting of copper, nickel, zinc, tin, silver, gold, aluminium, iron, chromium and alloys of these metals, with aluminium, tin, chromium-nickel and nickel-iron being particularly preferred. The film material can in principle be selected from all materials capable of undergoing vapour deposition with metal and of being used as a carrier film in adhesive tapes, for which polymers in particular are suitable. The material is selected in particular from polyesters and polyolefins, a mixture of a more than one material also being conceivable. Particularly preferred polyesters are polyethylene terephthalate (PET) and polyethylene naphthalate (PEN). Particularly preferred polyolefins are polypropylene (PP) and polyethylene (PE). In preferred embodiments, the film material is selected from the group consisting of PET, PEN, PE and PP. Preferably, it is a PET (polyethylene terephthalate) film. A film of this kind is dimensionally stable and therefore easy to process without significant stretching or tearing. This makes it possible to durably apply a homogeneous and gapless metal layer, with the result that the electrical conductivity, particularly in z direction, is durably guaranteed across the entire film. The film can be coated with metal in any manner known to the skilled person.

In the embodiments in which at least one electrically conductive carrier layer T or at least two electrically conductive carrier layers T and T′ are present, it is preferable in advantageous embodiments that this at least one adjacent adhesive layer protrudes laterally in at least one direction of extension of the layer plane and thus includes a lateral overhang. A voltage can then be applied to this lateral overhang in a simple manner.

In further advantageous embodiments, it is also conceivable and preferable that none of the carrier layers project beyond any other layer, in particular adjacent adhesive layer. This allows the composite of the layers to be easily processed collectively, in particular punched or otherwise converted to the desired shape. Such a structure thus has the advantage of simple producibility and, in addition, the possibility of adjusting the stability of the adhesive tape via the carrier layer(s). It is conceivable and preferable here too that two electrically conductive substrates A and B are bonded and the voltage is applied to these substrates. In this case, the electrically conductive carrier layer is a continuously conductive layer in z direction, in particular and preferably a metal foil according to the above option a)

The expression “laterally overhang” is understood in the context of the present invention as meaning any kind of lateral projection of the layer or layers concerned and means that the layer respectively concerned extends beyond the layer of reference, more particularly in the “xy” plane and thus laterally—perpendicular to stacking direction. In the context of the present invention, the terms “lateral extension” or “lateral extension portion” are also used instead of the term “lateral projection”.

The term “lateral” refers here to each direction of extension of the layer plane “xy” perpendicular to the stacking direction of the layers “z”. The term is thus in particular independent of the geometric shape of the adhesive tape in the “xy” plane, which can for example be a rectangle, as is customary for adhesive tapes (see above), but can also be a square or a circle. The term does not address minor fluctuations in the dimensions of the individual layers in the “xy” plane that result from the die-cutting method or similar shaping methods, particularly since the dimensions of such minor material projections preclude the application of a voltage thereto in the planned manner.

The adhesive layers C or C and C′ can in principle be based on the same compounds as the adhesive layer D; the adhesives of layers C or C and C do not have to contain any electrolytes, but may do. Preferably, the layers C or C and C′ do not contain any electrolytes.

Irrespective of this, the adhesives of layers C or C and C′ can be designed to be electrically conductive, so that a voltage can also be applied to them depending on the rest of the structure. Preferably, the electrically conductive adhesive layer comprises at least one metal for this purpose, such as in particular nickel, copper or silver, preferably in the form of electrically conductive metal particles and/or metallized particles, more preferably metal particles. Metal particles may be in any suitable forms, including dendritic metal particles.

Metallized particles are in particular and preferably glass or polymer particles metallized with at least one metal, with the result that the previously electrically non-conductive particles are made electrically conductive by the metallization. More preferably, the electrically conductive adhesive layer comprises electrically conductive particles selected from the group consisting of nickel particles, copper particles and silver-coated copper particles. In particularly preferred embodiments, the electrically conductive adhesive layer comprises nickel particles.

Preferably, the electrically conductive adhesive layer contains 5 to 40 parts by weight, more preferably 20 to 40 parts by weight, most preferably 25 to 35 parts by weight, of electrically conductive particles, more particularly metal particles and/or metallized particles, based on 100 parts by weight of polymers present.

A layer is considered to be “electrically conductive” in the context of the present invention in particular when the resistance is less than 1 ohm, as measured in the respective direction, in this case more particularly in z-direction, according to the standard MIL-DTL-83528C: 2001-01.

All electrically conductive layers in the context of this invention are electrically conductive at least in z direction. In particular, the layers to which a voltage is applied additionally have electrical conductivity in the x,y plane, perpendicular to z direction.

In the case of one (C) or two (C and C′) electrically conductive adhesive layers, the respective carrier layer T or T and/or T′ need not be electrically conductive, depending on the geometry and where the adhesive split is desired. Electrical conductivity therefore needs to be enabled only between the layers between which the voltage is applied.

Irrespective of whether adhesive layers C or C and/or C′ are designed to be electrically conductive, the statements that follow are applicable. The further adhesive layers C or C and/or C′ may be a layer based on a reactive heat-activatable adhesive, which may be the same as or different from the above-described adhesive of film D. The adhesive of the further adhesive layer C or C and/or C′ may also be an adhesive activatable by another type of activation, for example a structural adhesive activatable by UV light. Moreover, the adhesive of the further layer C may be a pressure-sensitive adhesive.

The adhesive of adhesive layer D and—depending on the embodiment—further adhesives are produced by known methods and converted to layer form, in particular by spreading. In addition, one or more drying steps may optionally be effected.

The laminating of all layers described one on top of another is effected in a manner known to the skilled person.

Advantageously, the outer, exposed surfaces of the adhesive layers of the adhesive tape of the invention can be provided with anti-adhesive materials, such as a release paper or a release film, also termed a liner or protective liner. A liner may also be a material having anti-adhesive coating on at least one side, preferably on both sides, for example double-sidedly siliconized material. A liner, or in more general terms a temporary carrier, is not part of an adhesive tape, but merely an auxiliary for the production and/or storage thereof and/or for further processing by die-cutting. Furthermore, a liner, as opposed to a permanent carrier, is not firmly bonded to an adhesive layer but instead functions as a temporary carrier, i.e. as a carrier that can be peeled away from the adhesive layer. “Permanent carriers” are also referred to synonymously simply as “carriers” in the present application.

The thickness of the individual adhesive layer(s) including film D (in z direction) is preferably from 10 to 300 μm, more preferably 15 to 150 μm, even more preferably from 20 to 100 μm, even more preferably from 25 to 70 μm.

The present invention also provides a method of electrically debonding the composite according to the invention, comprising at least the following method steps:
i.) applying a voltage at two different electrically conductive points of the assembly, the voltage being preferably from 1 to 50 V.

The voltage is applied in step i.) of the method according to the invention for electrical debonding of the composite.

Depending on the structure of the bonded composite, the voltage is applied to the respective electrically conductive layers.

In the case of the described composite A-P-D-P′-B or A-P-D-B comprising electrically conductive substrates A and B, the voltage is applied to these two substrates A and B. In the case of the described composite A-P-D-T′-D′-P′-B comprising electrically conductive substrates A and B, the voltage is applied to these two substrates A and B.

In the case of the described composite A-P-D-P′-T′ (or T-P-D-P′-B) comprising an electrically conductive substrate A (or B) and an electrically conductive carrier layer T′ (or T), the voltage is preferably applied to A and T′ or B and T.

In the case of the described composite T-P-D-P-T′ comprising the two electrically conductive carrier layers T and T′, with which in particular two electrically non-conductive substrates S and S′ are bonded to form S-C-T-P-D-P-T′-C′-S′, for example, the two carrier layers T and T′ are applied.

In summary, the method of electrically debonding the composite according to the above embodiments comprises at least the following method steps:
i.) applying a voltage at two different electrically conductive points of the assembly, the voltage being preferably from 1 to 50 V, more preferably 2 to 50 V,
wherein
the voltage is applied either to the electrically conductive substrate A and the electrically conductive substrate B or
to the electrically conductive substrate A and the electrically conductive carrier layer T′ or
to the electrically conductive carrier layer T and the electrically conductive substrate B or
to the electrically conductive carrier layer T and the electrically conductive carrier layer T′.

The voltage is in particular a DC voltage. The voltage is particularly preferably from 2 to 50 V. In advantageous embodiments, the voltage is 2 to 12 V, for example 9 V.

Such a voltage can in particular be applied by means of a battery in the immediate vicinity of the bond, such as, in particular and for example, in a mobile phone, tablet, etc., or by adding a battery from outside.

According to further preferred embodiments of the invention, the voltage is from 12 to 50 V, for example 30 V. This relatively high voltage allows redetachment to take place particularly rapidly; the voltage for this need only be applied for a few seconds.

Depending on the chosen voltage in particular, the duration of application of the voltage in step i.) can be from a few seconds, more particularly 2 seconds, up to 900 seconds, preferably up to 600 seconds. It is of course also conceivable for the voltage to be applied for a period of time longer than 900 seconds, particularly if the voltage is relatively low.

The method according to the invention for electrically debonding the composite according to the invention allows the substrates A and B, for example, to be debonded from one another in a swift and easy manner without too much force being required. Furthermore, no residues of adhesive film D remain on at least one substrate.

In some cases, especially after a prolonged separation method, there may be a thin residual film of the electrolytes used, in particular ionic liquids, on the detached substrate. However, it is removable in a simple manner, for example by rinsing with a suitable solvent.

The electrically conductive substrate in all embodiments may, for example, be a mobile phone casing made of metal, for example of aluminium or passivated aluminium, or steel. Further, it may be, for example, an electrically conductive coating, which may be an organic or inorganic coating, on an otherwise electrically conductive substrate or a substrate rendered electrically conductive in some other way.

In all embodiments, the electrically non-conductive substrate may in particular be a casing made of a non-conductive material, such as plastic, or a battery or other non-electrically conductive components, for example speakers.

As already explained, the invention is particularly suitable for bonding thermally sensitive substrates, for example anodized aluminium, polymers, displays and/or glass.

The present invention further provides for the use of the adhesive tape according to the invention for bonding of components in electronic devices, automobiles, medical devices and dental devices, and in the DIY sector and in the household. Possible uses include DIY (“do it yourself”) applications.

The present invention also provides for the use of the adhesive tape according to the invention the bonding of components in electronic devices, automobiles, medical devices and dental devices.

In the following, preferred embodiments of the invention are elucidated and described more particularly with reference to the accompanying figures. These figures show:

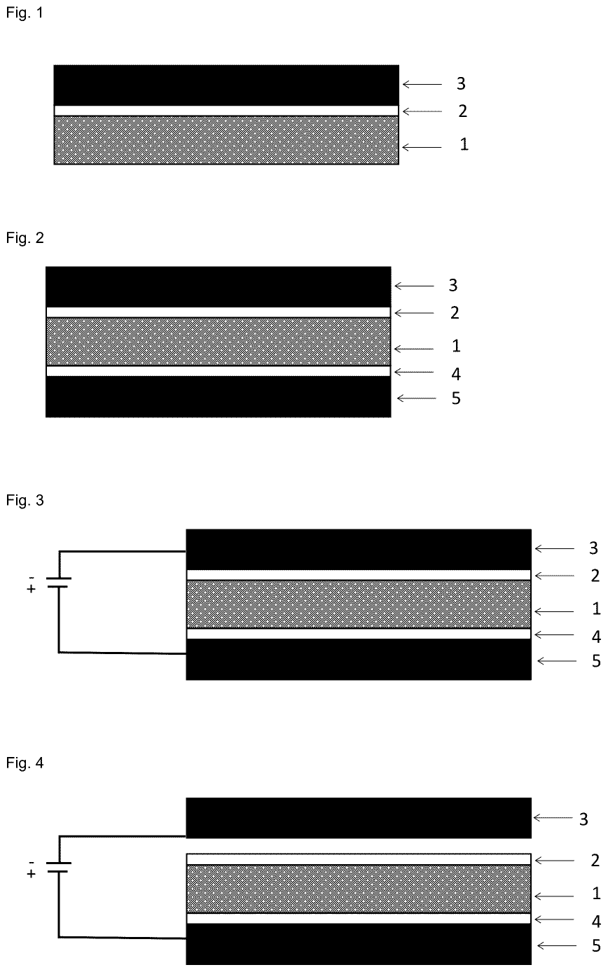

FIG. 1 a simplified schematic cross section through a bonded composite according to the invention in a preferred embodiment; and

FIG. 2 a simplified schematic cross section through a bonded composite according to the invention in a preferred embodiment; and

FIG. 3 a simplified schematic cross section through a bonded composite according to the invention to which a voltage is being applied, in a preferred embodiment; and

FIG. 4 a simplified schematic cross section through a bonded composite according to the invention after a voltage has been applied and an adhesive split has occurred as a result; and

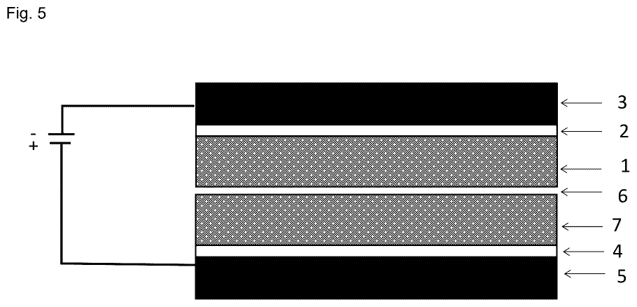

FIG. 5 a simplified schematic cross section through a bonded composite according to the invention in a preferred embodiment.

FIG. 1 shows a schematic diagram of the bonded composite according to the invention in a preferred embodiment. As apparent from FIG. 1, film D 1 is bonded to a first surface having an area of the first substrate A 3, with primer layer P 2 applied between film D 1 and substrate A 3.

FIG. 2 shows a schematic diagram of the bonded composite according to the invention in a preferred embodiment. As apparent from FIG. 2, film D 1 is bonded at a first surface having an area of the first substrate A 3, with primer layer P 2 applied between film D 1 and substrate A 3. In addition, film D 1 is bonded at a second surface having an area of the second substrate B 4, with a further primer layer P 4 applied between film D 1 and substrate B 5.

Substrates A 3 and B 5 are electrically conductive, and so a voltage can be applied to the two substrates, as shown schematically in FIG. 3.

The applying of the voltage results in significant lowering of the adhesion of adhesive layer D 1 to substrate A 3 and in the debonding of these layers from one another, as apparent from the schematic diagram in FIG. 4.

FIG. 5 shows a schematic diagram of the bonded composite according to the invention in a preferred embodiment. As apparent from FIG. 5, film D 1 is bonded at a first surface having an area of the first substrate A 3, with primer layer P 2 applied between film D 1 and substrate A 3. In addition, film D 1 is bonded to a second surface having an area of an electrically conductive carrier layer T′ 6. A second electrically conductive substrate B 5 is bonded to the carrier layer T′ 6 via a second heat-activatable film D′ 7. There is a second primer layer P′ 4 between the second film D′ and the second substrate B 5. The carrier layer T′ is in particular a nickel-iron foil. Films D 1 and D′ 7 in particular have the same composition. A voltage can be applied to the two substrates A 3 and B 5.

Alternatively, it would also be possible to apply a voltage to one of substrates A or B and carrier layer T′ 6, especially if this protrudes laterally somewhat from the composite (not shown in FIG. 5).

A number of examples are described hereinbelow for further illustration of the invention.

### Test Methods

Unless stated otherwise, all measurements are conducted at 23° C. and 50% relative humidity. The mechanical and adhesion data were determined as follows:

### Thickness

The thickness of an adhesive layer or film can be determined by determining the thickness of a section, defined in terms of its length and width, of such an adhesive layer applied to a liner, minus the (known or separately determinable) thickness of a section of the same dimensions of the liner used. For non-pressure-sensitive adhesive films, the use of a liner can be dispensed with and hence direct measurement is possible. The thickness of the adhesive layer can be determined with accuracies of less than 1 μm variance using commercially available thickness gauges (sensor test devices). If variances in thickness are detected, the mean value of measurements at not fewer than three representative sites is reported; in other words, there is in particular no measurement at creases, folds, nibs and the like.

As already described above for the thickness of an adhesive layer, it is also possible to analogously determine the thickness of an adhesive tape (adhesive strip) or of a carrier with accuracies of less than 1 μm variance using commercially available thickness gauges (sensor test devices). If variances in thickness are detected, the mean value of measurements at not fewer than three representative sites is reported; in other words, there is in particular no measurement at creases, folds, nibs and the like.

### Bond Strength—Push-Out

The push-out test enables conclusions as to the bond strength of a double-sided adhesive product in a bonded composite in the direction of the adhesive layer normal.

For this purpose, a square substrate S1 with outer dimensions of 33 mm×33 mm is provided. On one of the surfaces, the respective primer solution (or no primer, V1 and V2) is applied along the edges with a width of 5 mm, creating a 5 mm-wide frame with primer along the outer edges of the square substrate.

In addition, a square die-cut of the reactive heat-activatable adhesive film in the form of a frame is provided—prepared by punching by means of a die-cutter from the flat adhesive film: external dimensions 30 mm×30 mm; frame width 3.0 mm; internal dimensions (window cut-out) 27 mm×27 mm. The total surface area of the adhesive film frame to be examined is 170 mm².

In addition, a square, frame-shaped substrate S2 is provided: external dimensions 40 mm×40 mm; internal dimensions (window cut-out) 20 mm×20 mm.

On one of the surfaces, the respective primer solution (or no primer, V1 and V2) is applied along the inner edges of the frame with a width of 5 mm, creating a 5 mm-wide frame with primer along the inner edges of the square, frame-shaped substrate.

Substrates S1 and S2 are made of SUS steel and are cleaned with methyl ethyl ketone (MEK) before priming.

The primer is applied in each case by printing using a Nordson printer.

The solvent is then allowed to evaporate for at least two minutes up to a maximum of 20 minutes. The layer thickness of the primer layer after drying is 1.5 μm.

One of the substrates, for example S1, is placed on a hotplate preheated to 60° C. and preheated for at least 30 seconds.

The film provided of the reactive heat-activatable adhesive is positioned, if necessary after removal of a protective liner, on the preheated and primer-treated substrate by means of tweezers. It is pressed on with a rubber roller and left to cool briefly.

The second substrate, for example S2, is likewise placed on a heating plate preheated to 60° C. and preheated for at least 30 seconds. If necessary, any protective liner is removed from the surface of film D facing in z direction from the first substrate. The second substrate is then placed on the free surface of film D and pressed on. The composite thus prelaminated was then allowed to cool down.

The film is arranged between substrates S1 and S2 in such a way that the inner cutouts of the frame-shaped film and the substrate S2 are centred one on top of the other. As a result, the primer applied to the two substrates overhangs in different directions—opposite the film—so that no primer-treated surfaces without film touch one another in the bonded composite.

In the case of examples E1, V2, V3 and V4, pressing was effected in a laboratory heating press at ram temperature 65° C. and 5 bar for 600 s, thus creating a corresponding heat-activatable composite. In the case of example V1, pressing was effected in a laboratory heating press at ram temperature 90° C. and 5 bar for 300 s, thus creating a corresponding heat-activatable composite. The specimens obtained are stored at RT and 50% RH (standard climatic conditions) for 24 hours.

The frame format (substrate S2) projects beyond the format of substrate S1, and so the composite can be placed on a layout table by the protruding regions of the frame (substrate S2).

By means of a punch clamped in a tensile tester, constant forward movement of the punch through the opening in substrate S2 results in vertical pressure on substrate S1 and hence a force is exerted on the adhesive bond in the composite. The testing speed of the punch is 10 mm/s. The value recorded is the maximum force at which substrate S1 is detached from the frame (substrate S2). The force is based on the punch area, and so the result is push-out resistances in units of N/mm² or MPa. The test conditions are 23° C. and 50% relative humidity.

### Shock Resistance—DropTower

Sample preparation is the same as for the push-out test and with the same geometries.

The specimens obtained are stored at RT and 50% RH (standard climatic conditions) for 24 hours.

Immediately after the storage, the specimen is placed into the sample holder of the instrumented drop apparatus in such a way that the composite is horizontal with the steel window facing downward. The measurement is effected by instrument and automatically using a load weight of 5 kg and a drop height of 115 mm. The kinetic energy introduced by the load weight destroys the adhesive bond by fracture of the adhesive tape between window and frame, with the force being recorded by a piezoelectric sensor every μs. After the measurement, the associated software accordingly reports the graph for the force-time curve.

The force region below the curve is determined and the total energy is derived therefrom.

Five specimens of each sample were tested and the end result was the total energy from the mean of the five samples.

The following examples of bonded composites according to the invention (indicated by E) and comparative examples (indicated by V) were produced:

TABLE 1
Chemicals used:

| Name used / | | |
|---|---|---|
| Trade name | Supplier | Specification |
| Adhesive | | |
| Irostic ® S | Huntsman | hydroxyl-terminated, largely linear, |
| 9827-12 | | thermoplastic, highly crystalline |
| | | polyurethane elastomer; polymer component |
| Dancure ® | Danquinsa | 2,4-dioxo-1,3-diazetidine-1,3-bis(4-methyl- |
| 999 | GmbH | m-phenylene) diisocyanate; crosslinker |
| MEK | Shell | methyl ethyl ketone; |
| | | CAS 78-93-3 |
| EMIM-FSI | Proionic | ionic liquid; 1-ethyl-3-methylimidazolium |
| | GmbH | bis(trifluoromethylsulfonyl)imide; CAS |
| | | 235789-75-0 |
| Primer | | |
| composition | | |
| Laricol 1460 | Coim | thermoplastic polyurethane |
| GENIOSIL ® | Wacker | (3-triethoxysilylpropyl)succinic anhydride |
| GF20 | | (CAS No. 93642-68-3) |
| Ethyl | | anhydrous mixture of 80% by weight of |
| acetate/MEK | | ethyl acetate and 20% by weight of methyl |
| | | ethyl ketone (MEK) |

Film D was used for examples V1, V2, V3, V4 and E1 and was provided as follows: 87.0% by weight, based on the later total amount of the adhesive without solvent, of Irostic® S 9827-12 (polyurethane) was dissolved in MEK. Subsequently, 10.0% by weight of Dancure® 999 was added and intensively mixed with the dissolved polyurethane. Then 3.0% by weight of the ionic liquid 1-ethyl-3-methylimidazolium bis(trifluoromethylsulfonyl)imide (EMIM-FSI) was added and likewise mixed vigorously.

The reactive heat-activatable adhesive was then smeared from solution onto a glassine release paper (protective liner) and dried at 50° C. for 20 minutes. After drying, the layer thickness was 100 μm.

The respective composition of the primer and in some cases the activation temperature were varied. Inventive examples are indicated by “E” and comparative examples by “V”.
E1: The primer consisted of 4 g of thermoplastic polyurethane (Laricol 1460, from Coim), 1 g of (3-triethoxysilylpropyl)succinic anhydride (CAS No. 93642-68-3, GENIOSIL® GF20, from Wacker) and 95 g of an anhydrous mixture of 80% by weight of ethyl acetate and 20% by weight of methyl ethyl ketone (MEK);
V1: No primer was used;
V2: No primer was used;
V3: The primer consisted of 4 g of a polyacrylate (produced by polymerization of a monomer composition containing 70% by weight of butyl acrylate and 30% by weight of vinyl caprolactam, based in each case on the total weight of the monomers present in the monomer composition), 4 g of titanium tetraisopropoxide (TYZOR® TPT, Lehmann & Voss, CAS 546-68-9) and 92 g of isopropanol;
V4: The primer used was the commercially available product Sika® Primer-207 (from Sika).

The adhesive films and various primer solutions were used to produce specimens for the respective properties to be examined. The preparation, including the activation of the reactive heat-activatable adhesive of film D, is detailed in the method description for the push-out test.

Bond strengths and shock resistances have been determined by the above-specified methods. The results are collated in Table 2.

Subsequently, samples of the abovementioned examples were again produced and tested for electrical redetachability via the push-out test.

After bonding and activation, for this purpose, a voltage was applied to the two steel plates as representatives of conductive substrates A and B.

The applied voltage and the results obtained are likewise listed in Table 2.

TABLE 2

| | Unit | C1 | C2 | C3 | C4 | I1 |
|---|---|---|---|---|---|---|
| Activation temperature | ° C. | 90 | 65 | 65 | 65 | 65 |
| Bond strength before applying | MPa | 9.5 | 5.8 | 7.8 | 9.2 | 9.6 |
| a voltage | | | | | | |
| Bond strength after applying a | MPa | 0.2 | 0.2 | 3.1 | 9.1 | 0.3 |
| voltage of 9 V | | | | | | |
| Bond strength after applying a | MPa | 0.2 | 0.2 | 2.6 | 9.25 | 0.2 |
| voltage of 30 V | | | | | | |
| Shock resistance | J | 0.6 | 0.1 | 0.4 | 0.7 | 1.2 |

As apparent from the low bond strengths for E1 after applying a voltage in Table 2, the composite produced in accordance with the invention with use of a composition consisting of (a) a thermoplastic polyurethane and (b) an organosilane and—in this case for application—a solvent as primer is surprisingly electrically detachable. This is surprising because there is no electrolyte in the primer layers P, and in particular no added ionic liquid, in the bonded composite A-P-D-P—B.

Accordingly, the bond strengths after applying a voltage in examples V3 and V4, in which different primers were used for comparison, are distinctly higher. At the same time, higher bond strengths before applying a voltage are achieved in the case of E1 compared to V2 at the same activation temperature (65° C.) of the reactive adhesive film D. The bond strengths of E1 are at a similar level to those in the case of V1 without use of a primer but with distinctly higher activation temperature (90° C.). It has thus surprisingly also been possible to lower the activation temperature, which allows bonding of thermally sensitive substrates, for example anodized aluminium, polymers, displays and/or glass.

The comparison of V1 and of the other comparative examples V2 to V4 and E1 additionally shows that the composite produced in accordance with the invention shows higher shock resistance in the DropTower test.
The comparative examples are at a distinctly lower level in the orders of magnitude measured. The differences are not merely within the measurement tolerances.

### LIST OF REFERENCE NUMERALS

1 film D
2 primer layer P
3 electrically conductive substrate A
4 primer layer P′
electrically conductive substrate B
6 electrically conductive carrier layer T′
7 second film D′

1. Adhesive tape system comprising
(i) a film D of a reactive heat-activatable adhesive, where the reactive heat-activatable adhesive contains at least one electrolyte; and
(ii) a primer composition which is intended to form a separate layer and contains at least the following constituents:
(a) at least one thermoplastic polyurethane; and
(b) at least one organosilane.

2. The adhesive tape system according to claim 1, characterized in that the organosilane (b) is selected from the group consisting of trialkoxysilylalkyl succinic anhydrides, trialkoxyphenylsilanes, (3-mercaptopropyl)trialkoxysilanes, (3-aminopropyl)alkoxysilanes, 3-(2-aminoethylamino)propyltrialkoxysilanes, vinyltrialkoxysilanes, and (3-glycidyloxypropyl)trialkoxysilanes.

3. The adhesive tape system according to claim 2, characterized in that the alkyl moiety of the trialkoxysilylalkyl succinic anhydride is a linear alkylene group having 1 to 10 carbon atoms, and/or the alkoxy groups of the trialkoxysilylalkyl succinic anhydride are selected from methoxy group and ethoxy groups.

4. The adhesive tape system according to claim 1, characterized in that the organosilane (b) of the primer composition is (3-triethoxysilylpropyl)succinic anhydride.

5. The adhesive tape system according to claim 1, characterized in that the thermoplastic polyurethane (a) of the primer composition has no free isocyanate groups.

6. The adhesive tape system according to claim 1, characterized in that the reactive heat-activatable adhesive contains at least one thermoplastic elastomer, and the reactive heat-activatable adhesive contains an isocyanate-containing compound as crosslinker.

7. The adhesive tape system according to claim 6, characterized in that the thermoplastic elastomer is at least a thermoplastic polyurethane.

8. The adhesive tape system according to claim 1, characterized in that the reactive heat-activatable adhesive is based on an organic solvent.

9. The adhesive tape system according to claim 1, characterized in that the electrolyte is selected from the group consisting of ionic liquids and metal salts, more preferably ionic liquids.

10. The adhesive tape system according to claim 9, characterized in that the anion of the ionic liquid is selected from the group consisting of 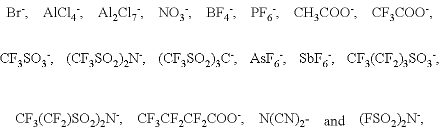
and/or the cation of the ionic liquid is selected from the group consisting of imidazolium-based cations, pyridinium-based cations, pyrrolidinium-based cations and ammonium-based cations.

11. Method of producing a bonded composite using the adhesive tape system according to claim 1, characterized in that it comprises at least the following method steps:
i. providing an electrically conductive substrate A or an electrically conductive carrier layer T;
ii. providing a film D of a reactive heat-activatable adhesive, where the reactive heat-activatable adhesive contains at least one electrolyte;
iii. providing a primer composition, where the primer composition contains at least the following constituents:
(a) at least one thermoplastic polyurethane; and
(b) at least one organosilane;
iv. contacting a surface of the first substrate A or a surface of carrier layer T with a first surface of film D;
v. where the contacting in step iv. between substrate A and the first surface of film D or carrier layer T and the first surface of film D is preceded by applying of the primer composition from step iii. as layer P;
x. activating film D by supplying heat at 40° C. or more and by application of a pressing pressure of more than 1 bar.

12. The method according to claim 11, characterized in that it additionally comprises at least the following method steps:
i. providing an electrically conductive substrate A or an electrically conductive carrier layer T;
ii. providing a film D of a reactive heat-activatable adhesive, where the reactive heat-activatable adhesive contains at least one electrolyte;
iii. providing a primer composition, where the primer composition contains at least the following constituents:
(a) at least one thermoplastic polyurethane; and
(b) at least one organosilane;
iv. contacting a surface of the first substrate A or a surface of carrier layer T with a first surface of film D;
v. where the contacting in step iv. between substrate A and the first surface of film D or carrier layer T and the first surface of film D is preceded by applying of the primer composition from step iii. as layer P;
vi. providing an electrically conductive substrate B or an electrically conductive carrier layer T′;
vii. contacting a surface of substrate B or a surface of carrier layer T′ with a second surface of film D;
viii. where the contacting in step vii. between substrate B and the second surface of film D or carrier layer T′ and the second surface of film D is optionally preceded by applying of the primer composition from step iii. as layer P′;
x. activating film D by supplying heat at 40° C. or more and by application of a pressing pressure of more than 1 bar.

13. Bonded composite produced by the method according to claim 12.

14. The method for electrically debonding the assembly according to claim 13, comprising at least the following method steps:
i.) applying a voltage to two different electrically conductive sites on the composite, where the voltage is preferably 1 to 50 V, more preferably 2 to 50 V, where the voltage is applied either to the electrically conductive substrate A and the electrically conductive substrate B or to the electrically conductive substrate A and the electrically conductive carrier layer T′ or to the electrically conductive carrier layer T and the electrically conductive substrate B or to the electrically conductive carrier layer T and the electrically conductive carrier layer T′.

15. A method of using the adhesive tape system according to claim 1 which comprises applying the adhesive tape system to a component of electronic devices, automobiles, medical devices, dental devices, DIY (do it yourself) projects and household products.

16. The adhesive tape system according to claim 3, characterized in that the alkyl moiety of the trialkoxysilylalkyl succinic anhydride is a linear alkylene group having 3 to 8 carbon atoms or a propylene group.

17. The adhesive tape system according to claim 6, characterized in that the at least one thermoplastic elastomer comprises functional groups that can react with isocyanate.

18. The adhesive tape system according to claim 10, characterized in that the anion of the ionic liquid is (CF₃SO₂)₂N⁻ or (FSO₂)₂N⁻, and/or the cation of the ionic liquid is selected from the group consisting of imidazolium-based cations.

19. A method of using the the bonded composite according to claim 13 which comprises applying the adhesive tape system to a component of electronic devices, automobiles, medical devices, dental devices, DIY (do it yourself) projects and household products.
